(19) United States
(12) Patent Application Publication
(10) Pub. No.: US 2020/0327554 A1
(43) Pub. Date: Oct. 15, 2020

(54) METHOD AND SYSTEM FOR DYNAMICALLY ALERTING CUSTOMER SERVICE EXECUTIVES FOR ENHANCING CUSTOMER SATISFACTION

(71) Applicant: TOSHIBA TEC KABUSHIKI KAISHA, Tokyo (JP)

(72) Inventors: Krishna PUTHRAN, Bangalore (IN); Megha SAKRIKAR, Bangalore (IN)

(73) Assignee: TOSHIBA TEC KABUSHIKI KAISHA, Tokyo (JP)

(21) Appl. No.: 16/506,593

(22) Filed: Jul. 9, 2019

(30) Foreign Application Priority Data
Apr. 9, 2019 (IN) 201941014299

(51) Int. Cl. G06Q 30/00; G06K 9/00; G06N 20/00

(52) U.S. Cl. CPC G06Q 30/016; G06K 9/00228; G06N 20/00; G06K 9/00281; G06K 9/00315

(57) ABSTRACT

Disclosed herein is method and customer service system for dynamically alerting a customer service executive for enhancing customer satisfaction. In one embodiment, a real-time video of actions performed by the customer service executive and the customer is captured. Subsequently, action labels corresponding to the actions of the customer service executive and state of the customer are determined based on the real-time video. Thereafter, when a negative state of the customer is detected, the action labels corresponding to the negative state of the customer be identified. Finally, the customer service executive is alerted about the actions associated with the identified action labels for enhancing the customer satisfaction.

### CROSS-REFERENCE TO RELATED APPLICATION

This application is based upon and claims the benefit of priority from Indian Patent Application No. 2019-41014299, filed on Apr. 9, 2019, the entire contents of which are incorporated herein by reference.

### TECHNICAL FIELD

The present disclosure matter is, in general, related to retail customer management and more particularly, but not exclusively, to methods and systems for dynamically alerting customer service executives to enhance customer satisfaction.

### BACKGROUND

Typically, in a retail environment, customer executives such as cashiers, customer service agents, and salespersons may be considered as the face of retail stores, as the customer executives are responsible for providing one-on-one personal services to customers in the retail stores. The customer executives may also be responsible for various miscellaneous functions such as ensuring appropriate billing and delivery of products, taking interest in listening to a customer's financial and medical concerns, ensuring safety of a customer's children while the customer is engaged elsewhere, responding to queries of the customers, and the like. Thus, the customer executives play a vital role in pleasing the customers and building a reputation for the retail stores.

However, in some instances, the actions of the customer executives may lead to customer dissatisfaction. For example, when customer executives fail to provide desired customer services, struggle to operate customer service systems, or are too slow to react to the customer requirements, the customer may become dissatisfied. Additionally, in most of the above instances, the customer executives may be so engrossed with their actions and may fail to realize that their actions have resulted in customer dissatisfaction. Therefore, it would be advantageous to have a mechanism that identifies relationships between the actions of the customer executives and customer dissatisfaction and that provides an opportunity for the customer executives to correct their actions or to take-up preventive measures to keep the customer satisfied.

The information disclosed in this background section of the present disclosure is only for enhancement of understanding of the general background of the invention and should not be taken as an acknowledgement or any form of suggestion that this information forms the prior art already known to a person skilled in the art.

### SUMMARY

Disclosed herein is a method for dynamically alerting a customer service executive for enhancing customer satisfaction. The method comprises capturing, by a customer service system, in real-time, a video of one or more actions performed by the customer service executive and a customer being attended by the customer service executive. Further, the method comprises determining action labels corresponding to each of the one or more actions performed by the customer service executive. Thereafter, the method comprises determining a state of the customer based on the one or more actions performed by the customer. The state of the customer is one of a positive state or a negative state. Subsequent to determining the state of the customer, the method comprises identifying, upon detecting the negative state of the customer, the action labels corresponding to the negative state of the customer. Finally, the method comprises alerting the customer service executive about the one or more actions associated with the identified action labels for enhancing the customer satisfaction.

Further, the present disclosure relates to a customer service system for dynamically alerting a customer service executive for enhancing customer satisfaction. The customer service system comprises a processor and a memory. The memory is communicatively coupled to the processor and stores processor-executable instructions, which on execution, cause the processor to capture, in real-time, a video of one or more actions performed by the customer service executive and a customer being attended by the customer service executive. Further, the instructions cause the processor to determine action labels corresponding to each of the one or more actions performed by the customer service executive. Thereafter, the instructions cause the processor to determine state of the customer based on the one or more actions performed by the customer. The state of the customer is one of a positive state of a negative state. Subsequent to determining the state of the customer, the instructions cause the processor to identify, upon detecting the negative state of the customer, the action labels corresponding to the negative state of the customer. Finally, the instructions cause the processor to alert the customer service executive about the one or more actions associated with the identified action labels for enhancing the customer satisfaction.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings, which are incorporated in and constitute a part of the present disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present disclosure are now described, by way of example only, and regarding the accompanying figures, in which:

FIG. 1 illustrates an exemplary environment for dynamically alerting a customer service executive for enhancing customer satisfaction in accordance with some embodiments of the present disclosure;

FIG. 2 shows a detailed block diagram illustrating a customer service system in accordance with some embodiments of the present disclosure;

FIG. 3A and FIG. 3B are exemplary representations of the user interface in accordance with some embodiments of the present disclosure;

FIG. 4 shows a flowchart illustrating a method of dynamically alerting a customer service executive for enhancing customer satisfaction in accordance with some embodiments of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present disclosure. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present disclosure described herein as “exemplary” is not necessarily to be construed as preferred or advantageous over other embodiments.

While the present disclosure is susceptible to various modifications and alternative forms, specific embodiments thereof have been shown by way of example in the drawings and will be described in detail below. It should be understood, however that it is not intended to limit the present disclosure to the specific forms disclosed, but on the contrary, the present disclosure is to cover all modifications, equivalents, and alternative falling within the scope of the present disclosure.

The terms “comprises,” “comprising,” “includes,” or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The present disclosure relates to a method and a customer service system for dynamically alerting a customer service executive for enhancing customer satisfaction. In an embodiment, the present disclosure discloses capturing a real-time video of actions performed by the customer service executives and the customer. Subsequently, the captured video may be analysed to extract customer emotion patterns and activities of the customer service executive. Further, a correlation between the customer emotion and the activities of the customer service executive may be drawn to determine relationship between the activities of the customer service executives and the emotions of the customer. For example, activities such as struggling to find right options on a point-of-sale (POS) machine, facing scanning issues, talking to other store staff and the like may trigger anger in the customer. Similarly, in instances when the customer is expecting some clarification, but the customer service executive is not listening to the customer or when the customer is being treated unprofessionally, the customer may feel unhappy or dissatisfied. Thus, in all the above scenarios, the method of present disclosure may be used to determine the activities of the customer service executives, which have caused unhappiness and/or dissatisfaction to the customer. Subsequently, the customer service executive may be dynamically alerted about the determined activities and/or reasons. Thereafter, the customer service executive may take up required corrective and/or preventive measures to enhance the customer satisfaction.

In the following detailed description of the embodiments of the present disclosure, reference is made to the accompanying drawings that form a part hereof, and in which are shown by way of illustration specific embodiments in which the present disclosure may be practiced. These embodiments are described in sufficient detail to enable those skilled in the art to practice the present disclosure, and it is to be understood that other embodiments may be utilized and that changes may be made without departing from the scope of the present disclosure. The following description is, therefore, not to be taken in a limiting sense.

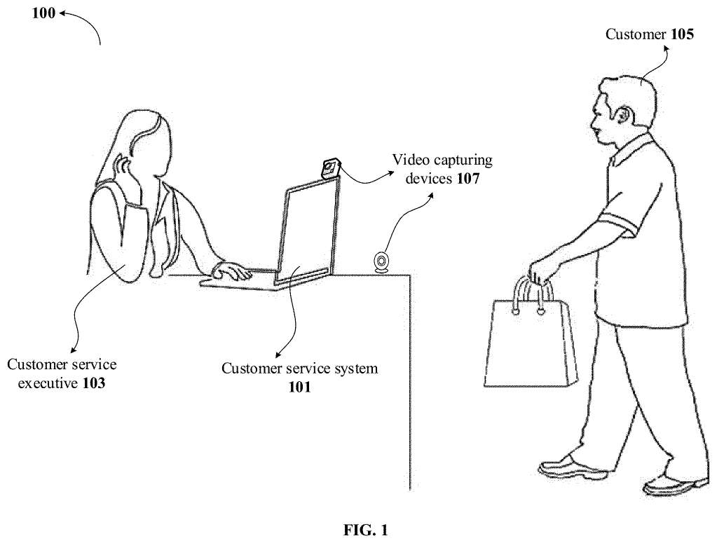

FIG. 1 illustrates an exemplary environment for dynamically alerting a customer service executive 103 for enhancing customer satisfaction in accordance with some embodiments of the present disclosure.

In an embodiment, the environment 100 may include, without limiting to, a customer service system 101, a customer service executive 103, and a customer 105. In an embodiment, the environment 100 may be a retail store such as, without limiting to, a shopping mall, a fashion and accessories store, an electronics device outlet, and the like. In another embodiment, the environment 100 may be any other establishment such as customer service centres, banks, ticket counters, saloons, and the like, where the customer 105 can avail a required service.

In an implementation, the customer service system 101 may be a computing system including, without limiting to, a desktop computer, a laptop, a server, a smartphone, a personal digital assistant (PDA), and the like, which may be configured to perform functionalities of the present disclosure. In an alternative implementation, the customer service system 101 may be a computing device associated with a POS device, an electronic data capture (EDC) device, or a display unit implemented in the environment 100. In yet another implementation, the POS device or the EDC device itself may be configured to operate as the customer service system 101. Also, in an embodiment, the customer service system 101 may be an external server, configured outside the environment 100, and commutatively interfaced with the POS or any other computing device implemented in the environment 100.

In an embodiment, the customer service system 101 may be associated and/or communicatively associated with one or more video capturing devices 107 for capturing one or more actions of the customer service executive 103 and the customer 105. In an implementation, as shown in FIG. 1, one of the video capturing devices 107 may be configured for capturing the one or more actions performed by the customer service system 101. Similarly, one of the video capturing devices 107 may be deployed to capture the one or more actions performed by the customer 105. In an alternative implementation, the video capturing devices 107 may be deployed in any other location within the environment 100, such that the video capturing devices 107 are capable of capturing the video of each of the one or more actions performed by the customer service executive 103 and the customer 105. In an embodiment, a single video capturing device 107 may be used for capturing each of the one or more actions performed by the customer service executive 103 and the customer 105. As an example, the video capturing devices 107 may include, without limiting to, closed-circuit television (CCTV) cameras, high definition (HD) CCTV cameras, digital cameras, Internet protocol (IP) cameras, webcams associated with the customer service system 101, and the like.

In an embodiment, the video capturing devices 107 may capture the video of the one or more actions in real-time and may transmit the captured video to the customer service system 101 in real-time. Alternatively, the video capturing devices 107 may be configured to convert the captured video into a plurality of image frames and transmit only required image frames to the customer service system 101 for further processing.

In an embodiment, the customer service executive 103 in the environment 100 may be a person including, without limiting to, a cashier, a salesperson, a receptionist, a customer service agent, an administrator, a storekeeper, and the like. That is, the customer service executive 103 may be any person responsible for attending and/or assisting the customer 105 in the environment 100. Further, the customer 105 may be a person including, without limiting to, a retail buyer or a purchaser of a service in the environment 100. In an embodiment, the one or more actions performed by the customer service executive 103 and the customer 105 may include, without limiting to, facial expressions, gestures, movements, and utterances made by the customer service executive 103 and the customer 105. In an embodiment, the facial expressions, gestures and the movements of the customer service executive 103 and the customer 105 may be extracted from the video captured by the video capturing devices 107.

In an embodiment, the customer service system 101 may be configured to receive the real-time video of the one or more actions, from the video capturing devices 107. Thereafter, the customer service system 101 may process and analyse the video using one or more predetermined video analysis techniques to determine action labels corresponding to each of the one or more actions performed by the customer service executive 103. As an example, the predetermined video analysis techniques configured in the customer service system 101 may include any existing video analytics techniques such as, without limiting to, video content analysis (VCA) technique, video motion detection technique, object identification and tracking technique, and the like.

In an embodiment, in addition to determining the action labels, the customer service system 101 may also determine a state of the customer 105 based on the one or more actions of the customer 105 captured in the video. As an example, the state of the customer 105 may include, without limiting to, mood of the customer 105, physical status of the customer 105, and the like. Further, the mood of the customer 105 may be one of customer 105 being angry, annoyed, sad, frustrated, happy, excited, and the like. Similarly, the physical status of the customer 105 may include conditions when the customer 105 is feeling tired, unable to stand, requires immediate medical assistance, and the like.

In an embodiment, the customer service system 101, may classify the state of the customer 105 as one of a positive state or a negative state. For example, when the mood of the customer 105 is happy, excited, joyful, peaceful, and the like, the state of the customer 105 may be detected as a positive state. Alternatively, when the mood of the customer 105 is angry, annoyed, frustrated, and the like, the state of the customer 105 may be detected as a negative state. Similarly, when the physical status of the customer 105 is a condition that the customer 105 is feeling tired and/or is unable to walk/stand, the state of the customer 105 may be detected as a negative state. In an embodiment, the negative state of the customer 105 may signify that the customer 105 is dissatisfied and/or unhappy with the service provided by the customer service executive 103.

In an embodiment, upon detecting the negative state of the customer 105, the customer service system 101 may correlate each of the action labels and the determined state of the customer 105 to identify the action labels corresponding to and/or resulting in the negative state of the customer 105. In an embodiment, the correlation between the action labels and the state of the customer 105 may be performed using pretrained deep learning models and/or machine learning models configured in the customer service system 101. In an embodiment, the machine learning model may be trained using historical actions performed by the customer 105, states associated with the historical actions performed by the customer 105, historical actions performed by the customer service executive 103 and action labels corresponding to the historical actions performed by the customer service executive 103. In other words, the customer service system 101 may use the trained machine learning models to determine relationship between the one or more actions of the customer service executive 103 and the state of the customer 105.

In an embodiment, upon identifying the action labels corresponding to the negative state of the customer 105, the customer service system 101 may identify the one or more actions of the customer service executive 103 that are associated with the identified action labels. Subsequently, the customer service system 101 may alert the customer service executive 103 about the one or more actions responsible for the negative state of the customer 105. Thereafter, the customer service executive 103 may change and/or avoid performing the one or more alerted actions for changing the state of the customer 105 and to enhance the customer satisfaction.

In an embodiment, customer service system 101 may alert the customer service executive 103 by providing one or more alert notifications and action recommendations to the customer service executive 103, through a user interface associated with the customer service system 101. As an example, the alert notifications may include information about the one or more actions that have resulted in the negative state of the customer 105. Similarly, the action recommendations may include suggestions and/or preventive measures that may be performed to address the negative state of the customer 105.

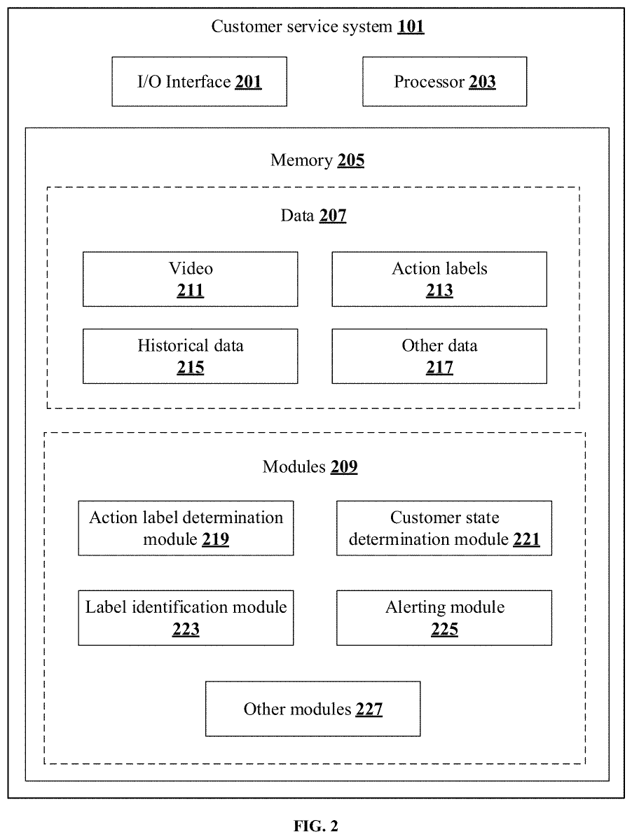

FIG. 2 shows a detailed block diagram illustrating a customer service system 101 in accordance with some embodiments of the present disclosure.

In some implementations, the customer service system 101 may include an input/output (I/O) interface 201, a processor 203, and a memory 205. The I/O interface 201 may be configured to, for example, receive a real-time video 211 and/or one or more image frames from a video capturing device 107 associated with the customer service system 101. The memory 205 may be communicatively coupled to the processor 203 and may store, for example, data 207 and one or more modules 209. The processor 203 may be configured to perform one or more functions of the customer service system 101 for dynamically alerting the customer service executive 103, using the one or more modules 209 and the data 207.

In an embodiment, the data 207 may include, without limitation, the video 211, action labels 213, historical data 215, and other data 217. In some implementations, the data 207 may be stored within the memory 205 in the form of various data structures. Additionally, the data 207 may be organized using data models, such as relational or hierarchical data models. The other data 217 may store various temporary data and files generated by the one or more modules 209 while performing various functions of the customer service system 101. As an example, the other data 217 may include, without limiting to, historical videos used for training the customer service system 101, machine learning models and/or deep learning models used for identifying the state of the customer 105, and the like.

In an embodiment, the video 211 may be received from the video capturing devices 107 associated with the customer service system 101. The video 211 may comprise one or more actions performed by the customer service executive 103 and the customer 105. As an example, the one or more actions may include, without limiting to, facial expressions, gestures, movements, and utterances made by the customer service executive 103 and the customer 105.

In an embodiment, the utterances of the customer service executive 103 and the customer 105 may be captured using a voice recording device, such as a microphone associated with the customer service system 101. Further, the captured utterances may be processed using an existing voice processing technique such as speech-to-text conversion or natural language processing (NLP) based processing technique, for determining the action labels corresponding to the utterances.

As an example, suppose the customer 105 utters a sentence such as “I have a flight to catch. Please make it quick”. The above utterance of the customer 105 may be analyzed to identify one or more keywords such as “flight,” “catch,” and “quick” for determining a present state of the customer 105. Further, the identified keywords may be compared with predetermined keywords, which are mapped against various states of the customer 105 based on historical data and learning of the customer 105 behavior. In the above example, the keywords “flight,” “catch,” and “quick” may indicate that the customer 105 is impatient. Accordingly, it may be determined that the state of the customer 105 is negative (that is, impatient). Consequently, the customer service executive 103 may be notified to quicken the service to customer 105 in order to effectively address the negative state of the customer 105.

In an embodiment, the action labels 213 may correspond to the respective one or more actions performed by the customer service executive 103. As an example, if the customer service executive 103 is seen continuously talking to other staffs in the environment 100, without attending a waiting customer 105, then an action label corresponding to the above action of the customer service executive 103 may be ‘ignorant.’ Similarly, if the customer service executive 103 is taking too long to attend the customer 105, the corresponding action label may be ‘delay’ or ‘slow.’ That is, the action labels 213 may be unique tags associated with each of the one or more actions performed by the customer 105, which help in identifying the nature of action performed by the customer service executive 103. In an embodiment, the action labels 213 may be determined by analyzing the video 211 comprising the one or more actions of the customer service executive 103.

In an embodiment, the historical data 215 may include, without limiting to, information related to historical actions performed by the customer 105, states associated with the historical actions performed by the customer 105, historical actions performed by the customer service executive 103 and action labels 213 corresponding to the historical actions performed by the customer service executive 103. In an embodiment, the historical data may be used for training a machine learning model, which may be subsequently used for identifying the action labels 213 corresponding to the negative state of the customer 105. Additionally, the historical data 215 may be used for training the customer service executives.

In an embodiment, the data 207 may be processed by the one or more modules 209. In some implementations, the one or more modules 209 may be communicatively coupled to the processor 203 for performing one or more functions of the customer service system 101. In an implementation, the one or more modules 209 may include, without limiting to, an action label determination module 219, a customer state determination module 221, a label identification module 223, an alerting module 225, and other modules 227.

As used herein, the term module refers to an application specific integrated circuit (ASIC), an electronic circuit, a processor (shared, dedicated, or group), and memory that execute one or more software or firmware programs, a combinational logic circuit, and/or other suitable components that provide the described functionality. In an embodiment, the other modules 227 may be used to perform various miscellaneous functionalities of the customer service system 101. It will be appreciated that such one or more modules 209 may be represented as a single module or a combination of different modules.

In an embodiment, the action label determination module 219 may be configured to determine the action labels 213 corresponding to each of the one or more actions performed by the customer service executive 103. In an embodiment, the action labels 213 may be determined by extracting each action sequence from the video 211 and then comparing the extracted action sequences with reference and/or predefined action labels 213 in the historical data 215.

In an embodiment, the customer state determination module 221 may be configured for determining the state of the customer 105 based on the one or more actions performed by the customer 105. Initially, the customer state determination module 221 may correlate each of the one or more actions performed by the customer 105 with a plurality of reference customer actions that are associated with a predetermined state. Subsequently, the customer state determination module 221 may identify a reference customer action corresponding to each of the one or more actions for classifying the one or more actions as one of the pluralities of reference customer actions. Thereafter, the state of the customer 105 may be determined as the predetermined state associated with the identified reference customer action.

In an embodiment, the label identification module 223 may be configured for identifying the action labels 213 corresponding to the one or more actions resulting in the negative state of the customer 105 using a pretrained machine learning model stored in the customer service system 101. In an embodiment, the pretrained machine learning model may be trained for dynamically building a correlation between the action labels 213 determined from the video 211 and the state of the customer 105 determined from the video 211. Additionally, the label identification module 223 and the machine learning model may be used to identify the one or more actions associated with the identified action labels 213, thereby determining the one or more actions that have resulted in the negative state of the customer 105.

In an embodiment, training the machine learning model may include processing and labelling the historical data 215 related to the customer service executive 103 and the customer 105. Further, one or more feature vectors corresponding to the historical data 215 may be created using the labelled historical data 215. Subsequently, the machine learning model may be trained using the one or more feature vectors. Thereafter, when a real-time video 211 of the one or more actions is provided to the machine learning model, the machine learning model may generate new feature vectors and determine the action labels 213 based on the feature vectors used for training the machine learning model.

In an embodiment, the alerting module 225 may be configured for generating and providing alerts about the one or more actions, causing the negative state of the customer 105, to the customer service executive 103. In an embodiment, the alerts may include, without limiting to, one or more alert notifications and action recommendations to the customer service executive 103. Further, alerts may be provided through a user interface, such as a display/monitor associated with the customer service system 101. As an example, when it is determined that the negative state of the customer 105 is caused due to an ignorant action of the customer service executive 103, a corresponding alert generated by the alerting module 225 may be a warning notification such as ‘customer needs your attention.’ When the above alert/warning is displayed on the user interface, the customer service executive 103 may realize that the customer 105 is expecting some assistance from the customer service executive 103. Accordingly, the customer service executive 103 may perform one or more corrective and/or preventive actions to change the state of the customer 105. As an example, in the above scenario, the customer service executive 103 may immediately attend to the requirements of the customer 105 to please the customer 105 and thereby enhancing the customer satisfaction.

In an embodiment, there may be scenarios in which the customer 105 is in a negative state, but the customer service executive 103 has not performed any action causing the negative state of the customer 105. To effectively handle the above scenarios, the customer service system 101 may be configured to intelligently correlate the state of the customer 105 and the one or more actions performed by the customer service executive 103 to decide whether the negative state of the customer 105 is caused by the one or more actions performed by the customer service executive 103 or otherwise. Thereafter, corresponding alerts and/or notifications may be generated and provided to the customer service executive 103 through the user interface.

In some embodiments, the customer service system 101 of the present disclosure may be used for training the inexperienced customer service executives 103. Here, the machine learning model, which is trained with historical data 215 related to various customer service executives 103 and the customers 105, may be used for the training. Additionally, the customer service system 101 may be used for assessing and improving the executive skills of the customer service executives 103.

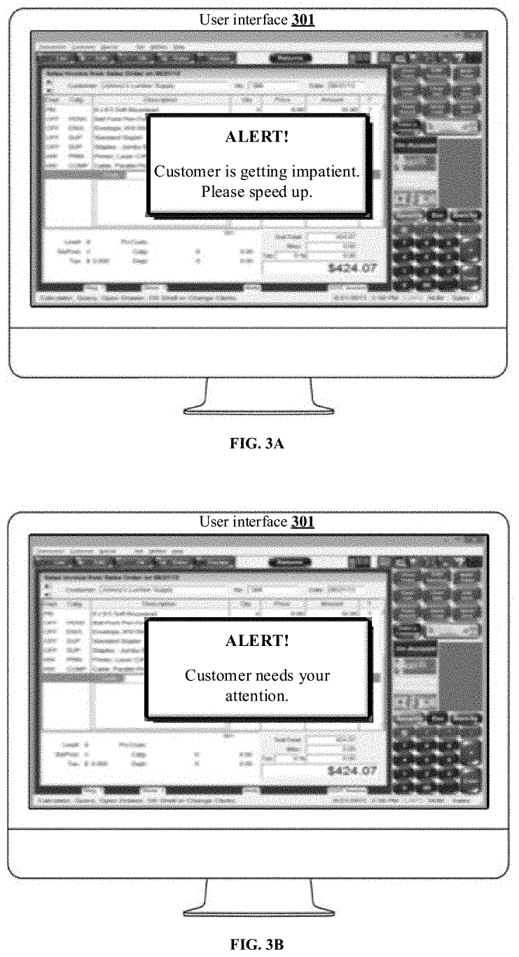

FIG. 3A and FIG. 3B illustrate exemplary representations of the user interface 301 in accordance with some embodiments of the present disclosure.

In an implementation, as shown in FIG. 3A and FIG. 3B, the user interface 301 may be a display/monitor associated with the customer service system 101 such as the POS device. In an embodiment, when the customer 105 is in a positive state and/or when the negative state of the customer 105 is not determined, the user interface 301 may be configured to display information related to one or more goods/services being purchased by the customer 105. However, once the negative state of the customer 105 is detected, the user interface 301 may be configured to dynamically provide alerts/notifications about the one or more actions of the customer service executive 103, which have caused the negative state of the customer 105. In one embodiment, the alert may be provided as a pop-up notification on the user interface 301 as shown in FIG. 3A and FIG. 3B. Alternatively, the alert may be provided as a voice message or a sound alert.

In an embodiment, as shown in FIG. 3A, the alert may include information related to the negative state of the customer (for example, customer is getting impatient) and a recommendation (for example, ‘please speed up’) for the customer service executive 103 for correcting and preventing the negative state of the customer 105. In an embodiment, as shown in FIG. 3B, the alert provided on the user interface 301 may be just an indication (for example, ‘customer needs your attention’) to the customer service executive 103 that the customer 105 is in need of assistance/attention from the customer service executive 103. In an embodiment, the nature/type of alerts to be provided to the customer service executive 103 may be customized by the customer service executive 103, according to his/her convenience and requirement.

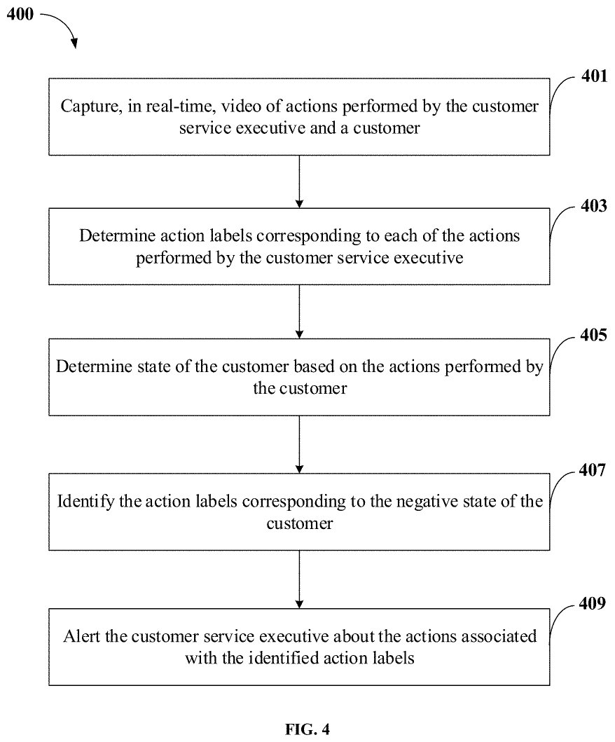

FIG. 4 shows a flowchart illustrating a method of dynamically alerting a customer service executive 103 for enhancing customer satisfaction in accordance with some embodiments of the present disclosure.

As illustrated in FIG. 4, the method 400 may include one or more blocks illustrating a method for dynamically alerting a customer service executive 103 for enhancing customer satisfaction using the customer service system 101 illustrated in FIG. 1. The method 400 may be described in the general context of computer executable instructions. Generally, computer executable instructions can include routines, programs, objects, components, data structures, procedures, modules, and functions, which perform specific functions or implement specific abstract data types.

The order in which the method 400 is described is not intended to be construed as a limitation, and any number of the described method blocks can be combined in any order to implement the method. Additionally, individual blocks may be deleted from the methods without departing from the scope of the disclosure described herein. Furthermore, the method can be implemented in any suitable hardware, software, firmware, or combination thereof.

At block 401, the method 400 includes capturing, by the customer service system 101, a video 211 of one or more actions performed by the customer service executive 103 and a customer 105 being attended by the customer service executive 103. In an embodiment, the video 211 may be captured in real-time using a video capturing device associated with the customer service system 101.

At block 403, the method 400 includes determining, by the customer service system 101, action labels 213 corresponding to each of the one or more actions performed by the customer service executive 103. In an embodiment, the one or more actions performed by the customer service executive 103 and the customer 105 may include, without limiting to, facial expressions, gestures, movements, and utterances made by the customer service executive 103 and the customer 105.

At block 405, the method 400 includes determining, by the customer service system 101, the state of the customer 105 based on the one or more actions performed by the customer 105. In an embodiment, the state of the customer 105 may be classified as one of a positive state or a negative state. In an embodiment, determining the state of the customer 105 may include correlating each of the one or more actions performed by the customer 105 with reference customer actions, in which, each of the reference customer actions are associated with a predetermined state. Thereafter, reference customer actions corresponding to each of the one or more actions may be identified. Finally, the state of the customer 105 may be determined as the predetermined state associated with the identified reference customer actions.

At block 407, the method 400 includes identifying, by the customer service system 101, upon detecting the negative state of the customer 105, the action labels 213 corresponding to the negative state of the customer 105. In other words, at block 407, the method comprises identifying the one or more actions of the customer service executive 103, which may have resulted in the negative state of the customer 105. In an implementation, the action labels 213 corresponding to the negative state of the customer 105 may be identified using a pretrained machine learning model. In an embodiment, the pretrained machine learning model may be trained using historical actions performed by the customer 105, states associated with the historical actions performed by the customer 105, historical actions performed by the customer service executive 103, and action labels 213 corresponding to the historical actions performed by the customer service executive 103.

At block 409, the method 400 includes alerting, by the customer service system 101, the customer service executive 103 about the one or more actions associated with the identified action labels 213 for enhancing the customer satisfaction. In an embodiment, alerting the customer service executive 103 may include providing one or more alert notifications and action recommendations to the customer service executive 103. In an implementation, the one or more alert notifications and action recommendations may be provided and/or notified on a user interface 301 associated with the customer service system 101.

### Computer System

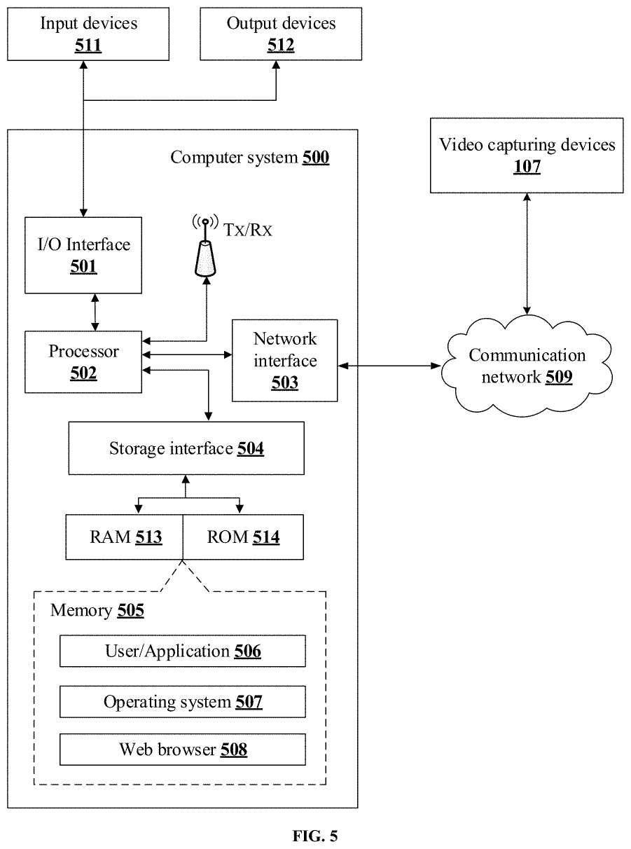

FIG. 5 illustrates a block diagram of an exemplary computer system 500 for implementing embodiments consistent with the present disclosure. In an embodiment, the computer system 500 may be the customer service system 101 illustrated in FIG. 1, which may be used for dynamically alerting a customer service executive 103 for enhancing customer satisfaction. The computer system 500 may include a central processing unit (“CPU” or “processor”) 502. The processor 502 may comprise at least one data processor for executing program components for executing user- or system-generated business processes. A user may include a person, a customer service executive 103, a retail operator, a cashier, or any other person, system/sub-system associated with the computer system 500. The processor 502 may include specialized processing units such as integrated system (bus) controllers, memory management control units, floating point units, graphics processing units, digital signal processing units, etc.

The processor 502 may be disposed in communication with one or more input/output (I/O) devices (511 and 512) via an I/O interface 501. The I/O interface 501 may employ communication protocols/methods such as, without limitation, audio, analog, digital, stereo, IEEE®-1394, serial bus, universal serial bus (USB), infrared, PS/2, BNC, coaxial, component, composite, digital visual interface (DVI), high-definition multimedia interface (HDMI), radio frequency (RF) antennas, S-Video, video graphics array (VGA), IEEE® 802.n /b/g/n/x, Bluetooth, cellular (e.g., dode-division multiple access (CDMA), high-speed packet access (HSPA+), global system for mobile communications (GSM), long-term evolution (LTE), or the like), etc. Using the I/O interface 501, the computer system 500 may communicate with one or more I/O devices 511 and 512.

In some embodiments, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), transmission control protocol/Internet protocol (TCP/IP), token ring, IEEE® 802.11a/b/g/n/x, etc. Using the network interface 503 and the communication network 509, the computer system 500 may communicate with a video capturing device 107, associated with the customer service system 101, for receiving a video 211 and/or one or more images comprising the one or more actions performed by the customer service executive 103 and the customer 105.

In an implementation, the communication network 509 may be implemented as one of the several types of networks, such as intranet or local area network (LAN) and such within the organization. The communication network 509 may either be a dedicated network or a shared network, which represents an association of several types of networks that use a variety of protocols, for example, hypertext transfer protocol (HTTP), TCP/IP, wireless application protocol (WAP), etc., to communicate with each other. Further, the communication network 509 may include a variety of network devices, including routers, bridges, servers, computing devices, storage devices, etc.

In some embodiments, the processor 502 may be disposed in communication with a memory 505 (e.g., RAM 513, ROM 514, etc. as shown in FIG. 5) via a storage interface 504. The storage interface 504 may connect to memory 505 including, without limitation, memory drives, removable disc drives, etc., employing connection protocols such as serial advanced technology attachment (SATA), integrated drive electronics (IDE), IEEE-1394, USB, fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 505 may store a collection of program or database components, including, without limitation, user/application interface 506, an operating system 507, a web browser 508, and the like. In some embodiments, computer system 500 may store user/application data 506, such as the data, variables, records, etc. as described in the present disclosure. Such databases may be implemented as fault-tolerant, relational, scalable, secure databases such as Oracle® or Sybase®.

The operating system 507 may facilitate resource management and operation of the computer system 500. Examples of operating systems include, without limitation, APPLE® MACINTOSH® OS X®, UNIX®, UNIX-like system distributions (e.g., BERKELEY SOFTWARE DISTRIBUTION® (BSD), FREEBSD®, NETBSD®, OPENBSD, etc.), LINUX® DISTRIBUTIONS (e.g., RED HAT®, UBUINTU®, KUBUNTU®, etc.), IBM° OS/2®, MICROSOFT® WINDOWS® (e.g., XP®, VISTA®/7/8, 10 etc.), APPLE® IOS®, GOOGLE™ ANDROID™, BLACKBERRY® OS, or the like.

The user interface 506 may facilitate display, execution, interaction, manipulation, or operation of program components through textual or graphical facilities. For example, the user interface 506 may provide computer interaction interface elements on a display system operatively connected to the computer system 500, such as cursors, icons, check boxes, menus, scrollers, windows, widgets, and the like. Further, graphical user interfaces (GUIs) may be employed, including, without limitation, APPLE® MACINTOSH® operating systems Aqua®, IBM® OS/2®, MICROSOFT® WINDOWS® (e.g., Aero, Metro, etc.), web interface libraries (e.g., ActiveX®, JAVA®, JAVASCRIPT®, AJAX, HTML, ADOBE® FLASH®, etc.), or the like.

The web browser 508 may be a hypertext viewing application. Secure web browsing may be provided using secure hypertext transport protocol (HTTPS), secure sockets layer (SSL), transport layer security (TLS), and the like. The web browsers 508 may utilize facilities such as AJAX, DHTML, ADOBE® FLASH®, JAVASCRIPT®, JAVA®, application programming interfaces (APIs), and the like. Further, the computer system 500 may implement a mail server stored program component. The mail server may utilize facilities such as ASP, ACTIVEX®, ANSI®, C++/C#, MICROSOFT®, .NET, CGI SCRIPTS, JAVA®, JAVASCRIPT®, PERl®, PHP, PYTHON®, WEBOBJECTS , etc. The mail server may utilize communication protocols such as Internet message access protocol (IMAP), messaging application programming interface (MAPI), MICROSOFT® exchange, post office protocol (POP), simple mail transfer protocol (SMTP), or the like. In some embodiments, the computer system 500 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, and the like.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include random access memory (RAM), read-only memory (ROM), volatile memory, nonvolatile memory, hard drives, compact disc (CD) ROMs, digital video disc (DVDs), flash drives, disks, and any other known physical storage media.

### Advantages of the Embodiments of the Present Disclosure are Illustrated Herein.

In an embodiment, the method of present disclosure helps in dynamically alerting customer service executives for enhancing customer satisfaction.

In an embodiment, the customer service system of the present disclosure helps in automatically identifying and alerting activities of the customer service executives that result in customer dissatisfaction. As a result, the present disclosure provides an opportunity for the customer service executives to avoid performing activities that result in customer dissatisfaction.

In an embodiment, the customer service system of the present disclosure may be used for training the customer service executives about enhancing the customer satisfaction.

The terms “an embodiment,” “embodiment,” “embodiments,” “the embodiment,” “the embodiments,” “one or more embodiments,” “some embodiments,” and “one embodiment” mean “one or more (but not all) embodiments of the invention(s)” unless expressly specified otherwise.

The terms “including,” “comprising,” “having,” and variations thereof mean “including but not limited to,” unless expressly specified otherwise.

The enumerated listing of items does not imply that any or all the items are mutually exclusive, unless expressly specified otherwise. The terms “a,” “an,” and “the,” mean “one or more,” unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present disclosure need not include the device itself.

Finally, the language used in the specification has been principally selected for readability and instructional purposes, and it may not have been selected to delineate or circumscribe the present disclosure. It is therefore intended that the scope of the present disclosure be limited not by this detailed description, but rather by any claims that issue on an application based here on. Accordingly, the embodiments of the present disclosure are intended to be illustrative, but not limiting, of the scope of the present disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Reference Numerals:

| Reference Number | Description |
|---|---|
| 100 | Environment |
| 101 | Customer service system |
| 103 | Customer service executive |
| 105 | Customer |
| 107 | Video capturing devices |
| 201 | I/O interface |
| 203 | Processor |
| 205 | Memory |
| 207 | Data |
| 209 | Modules |
| 211 | Video |
| 213 | Action labels |
| 215 | Historical data |
| 217 | Other data |
| 219 | Action label determination module |
| 221 | Customer state determination module |
| 223 | Label identification module |
| 225 | Alerting module |
| 227 | Other modules |
| 301 | User interface |
| 500 | Exemplary computer system |
| 501 | I/O Interface of the exemplary computer system |
| 502 | Processor of the exemplary computer system |
| 503 | Network interface |
| 504 | Storage interface |
| 505 | Memory of the exemplary computer system |
| 506 | User/Application |
| 507 | Operating system |
| 508 | Web browser |
| 509 | Communication network |
| 511 | Input devices |
| 512 | Output devices |
| 513 | RAM |
| 514 | ROM |

What is claimed is:

1. A method of dynamically alerting a customer service executive for enhancing customer satisfaction, the method comprising:
capturing, by a customer service system, in real-time, a video of one or more actions performed by at least one of a customer service executive or a customer being attended to by the customer service executive;
determining, by the customer service system, action labels corresponding to each of the one or more actions;
determining, by the customer service system, a state of the customer based on the one or more actions, wherein the state of the customer is one of a positive state or a negative state;
identifying, by the customer service system, upon determining that the state of the customer is the negative state, at least one negative action label from the action labels, the at least one negative action label corresponding to the negative state;
determining, by the customer service system, at least one negative action of the one or more actions, each of the at least one negative action corresponding to one of the at least one negative action label; and
displaying, by the customer service system, an alert to the customer service executive, the alert associated with the at least one negative action.

2. The method of claim 1, wherein the one or more actions comprise at least one of facial expressions, gestures, movements, or utterances.

3. The method of claim 1, wherein determining the state of the customer comprises:
correlating, by the customer service system, each of the one or more actions with at least one reference customer action, wherein each of the at least one reference customer actions is associated with one of the positive state or the negative state; and
determining, by the customer service system, the state of the customer based on the at least one reference customer action associated with the at least one negative action.

4. The method of claim 1, wherein the at least one negative action label is identified using a pretrained machine learning model.

5. The method of claim 4, wherein the pretrained machine learning model is trained using historical actions performed by the customer, states associated with the historical actions performed by the customer, historical actions performed by the customer service executive, and at least one of the action labels corresponding to the historical actions performed by the customer service executive.

6. The method of claim 1, wherein displaying the alert comprises providing one or more alert notifications and action recommendations to the customer service executive through a user interface associated with the customer service system.

7. A customer service system for dynamically alerting a customer service executive for enhancing customer satisfaction, the customer service system comprising:
a processor; and
a memory, communicatively coupled to the processor, wherein the memory stores processor-executable instructions, which on execution, cause the processor to:
capture, in real-time, a video of one or more actions performed by at least one of the customer service executive or a customer being attended by the customer service executive;
determine action labels corresponding to each of the one or more actions;
determine state of the customer based on the one or more actions, wherein the state of the customer is one of a positive state or a negative state;
identify, upon detecting the state of the customer is the negative state, at least one negative action label from the action labels, the at least one negative action label corresponding to the negative state;
determining at least one negative action of the one or more actions, each of the at least one negative action corresponding to one of the at least one negative action label; and
displaying an alert to the customer service executive, the alert associated with the at least one negative action.

8. The customer service system of claim 7, wherein the one or more actions comprise at least one of facial expressions, gestures, movements, and utterances.

9. The customer service system of claim 7, wherein the processor is configured to determine the state of the customer by:
correlating each of the one or more actions with at least one reference customer action, wherein each of the at least one reference customer action is associated with one of the positive state or the negative state; and
determining the state of the customer based on the at least one reference customer action associated with the at least one negative action.

10. The customer service system of claim 7, wherein the processor identifies the at least one negative action label using a pretrained machine learning model.

11. The customer service system of claim 10, wherein the pretrained machine learning model is trained using historical actions performed by the customer, states associated with the historical actions performed by the customer, historical actions performed by the customer service executive, and at least one of the action labels corresponding to the historical actions performed by the customer service executive .

12. The customer service system of claim 7, wherein displaying the alert comprises providing one or more alert notifications and action recommendations to the customer service executive, through a user interface associated with the customer service.

13. A system comprising:
a video camera configured to obtain video of a customer service executive and a customer;
a display device configured to selectively display an alert to the customer service executive; and
a device communicable with the display device, the device configured to:
analyse the video to detect the customer and the customer service executive;
analyse the video to determine a customer action associated with the customer in response to detecting the customer;
analyse the video to determine a customer service executive action associated with the customer service executive in response to detecting the customer service executive;
determine a state of the customer based upon at least one of the customer action or the customer service executive action, the state of the customer being one of a negative state or a positive state; and
cause the display device to display the alert in response to determining that the customer is in the negative state.

14. The system of claim 13, wherein:
the alert comprises text; and
the device is further configured to determine the text based upon the at least one of the customer action or the customer service executive action.
